(19) United States
(12) Patent Application Publication
(10) Pub. No.: US 2009/0101476 A1
(43) Pub. Date: Apr. 23, 2009

(54) METHODS AND APPARATUSES FOR CONTROLLED DISCHARGE

(75) Inventors: Ron J. Zorn, Crystal Lake, IL (US); Todd Danielczyk, Palatine, IL (US); Ronald Fruit, Woodstock, IL (US); Tobin L. Imes, Crystal Lake, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: GENERAL KINEMATICS CORPORATION, Crystal Lake, IL (US)

(21) Appl. No.: 12/253,589

(22) Filed: Oct. 17, 2008

Related U.S. Application Data
(60) Provisional application No. 60/981,450, filed on Oct. 19, 2007.

(51) Int. Cl. B65G 65/44

(52) U.S. Cl. 198/617; 198/533

(57) ABSTRACT

A vibratory apparatus includes a surface having an input end and an output end, and a vibratory generator coupled to the surface to cause material to move along the surface. The apparatus also includes a barrier coupled to the surface and having a plurality of openings disposed therethrough to provide for controlled passage of materials from an upstream side of the barrier to a downstream side, and a solid gate disposed to one side of the barrier, the gate moveable relative to the barrier between a first position wherein a first portion of the plurality of openings are occluded and a second position wherein a second portion of the plurality of openings are occluded, the first portion being different than the second portion. A method of operating such an apparatus is also provided.

This application claims the benefit of U.S. Application No. 60/981,450, filed Oct. 19, 2007, which is hereby incorporated by reference in its entirety in the present application.

### BACKGROUND

This patent is directed to methods and apparatuses for controlling discharge of materials from vibratory equipment, and, in particular, to methods and apparatuses for controlling discharge of materials from a vibratory drum.

### SUMMARY

According to an aspect of the present disclosure, a vibratory apparatus includes a surface having an input end and an output end, and a vibratory generator coupled to the surface to cause material to move along the surface. The apparatus also includes a barrier coupled to the surface and having a plurality of openings disposed therethrough to provide for controlled passage of materials from an upstream side of the barrier to a downstream side. Further, the apparatus includes a solid gate disposed to one side of the barrier, the gate moveable relative to the barrier between a first position wherein a first portion of the plurality of openings are occluded and a second position wherein a second portion of the plurality of openings are occluded, the first portion being different than the second portion.

According to another aspect of the present disclosure, a method of operating a vibratory apparatus is provided. The apparatus includes a container having an input end and an output end, a vibratory generator coupled to the container to cause material to move through the container between the input end and the output end, and a barrier coupled to the surface and having a plurality of openings disposed therethrough to provide for controlled passage of materials from an upstream side of the barrier to a downstream side. The method includes disposing a solid gate to one side of the barrier at a first position wherein a first portion of the plurality of openings are occluded, and moving the solid gate to a second position wherein a second portion of the plurality of openings are occluded, the first portion being different than the second portion, the movement of the solid gate between the first and second positions varying the bed depth of material within the container.

### BRIEF DESCRIPTION OF THE DRAWINGS

FIG. 1 is a front view of an apparatus for removing particulate materials according to the present disclosure with a discharge chute removed;

FIG. 2 is an end view of the apparatus of FIG. 1 looking down the apparatus from an input end;

FIG. 3 is a rear view of the apparatus of FIG. 1;

FIG. 4 is an enlarged, end view showing the a discharge device including a barrier and a gate according to the apparatus of FIG. 1; and

FIG. 5 is an enlarged, fragmentary, cross-sectional view showing the barrier, the gate and the discharge chute.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

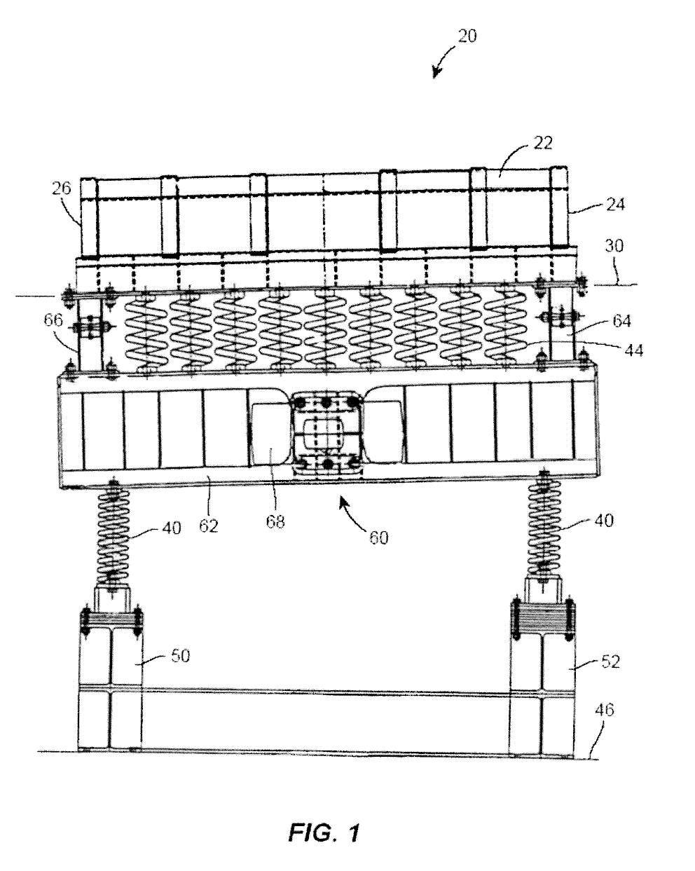

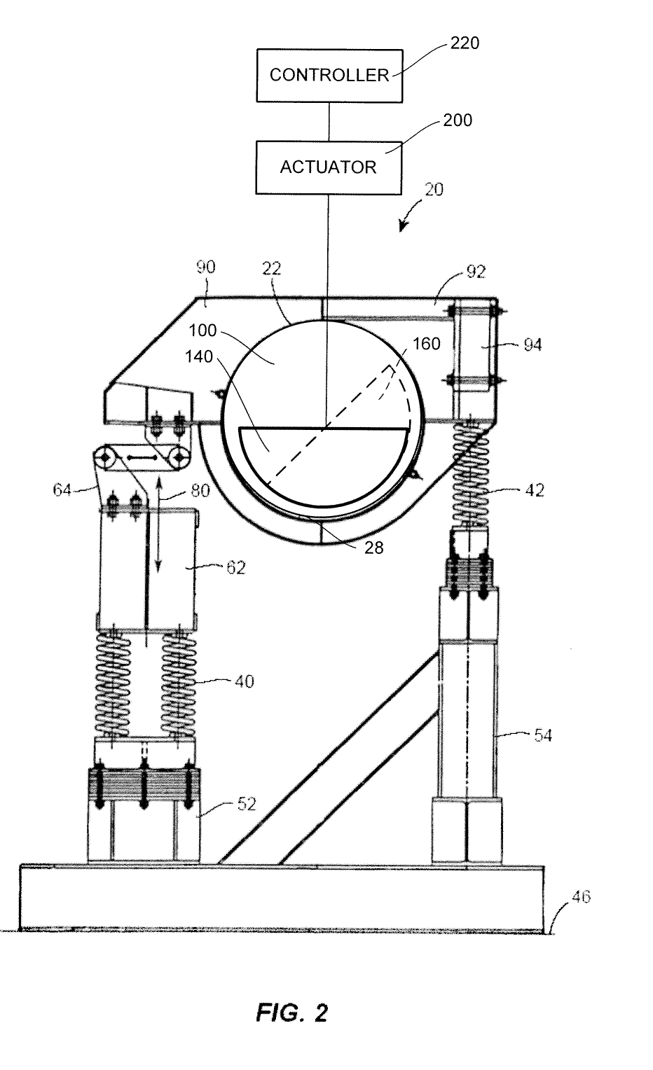

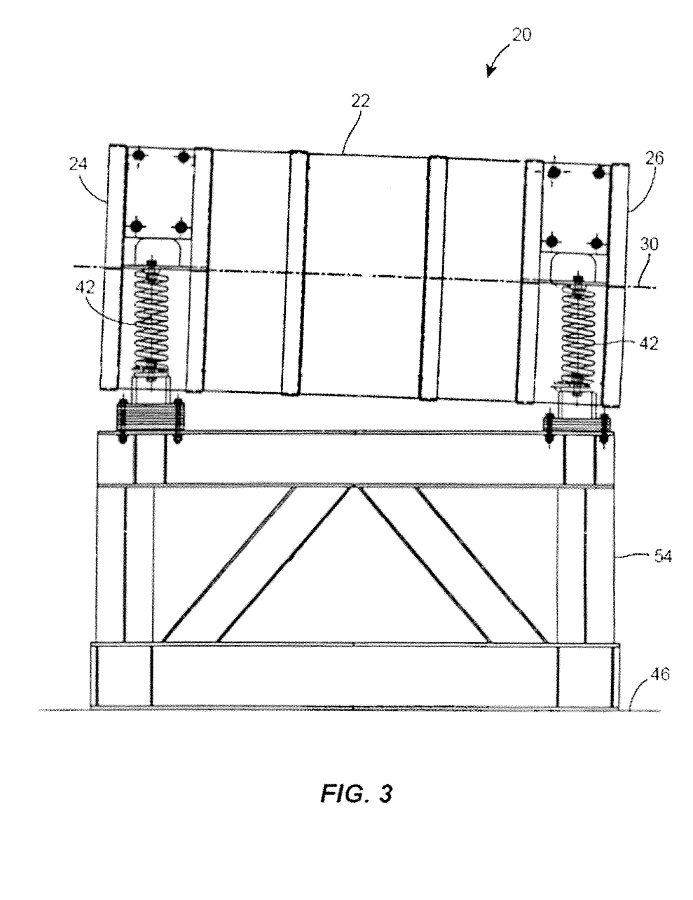

Referring first to FIG. 1, an apparatus 20 includes a cylindrical drum or container 22. The container 22 has an input end 24, and an axially-spaced output end 26 opposite the input end 24. As seen in FIG. 2, the container 22 has a curved inner surface 28 disposed about a generally horizontally extending longitudinal axis 30 (appearing as a point in FIG. 2, and as a line in FIGS. 1 and 3).

The container 22 is mounted on a plurality of resilient members, or springs, 40, 42, 44 so as to be resiliently supported above a base 46. The springs 40 isolate the container 22 from the base 46 on one side, while the springs 42 isolate the container 22 from the base 46 on the other side. The springs 40, 42 may be set apart from the base 46 by, for example, steel columns 50, 52 (FIG. 1) and a steel support structure 54 (FIGS. 2 and 3), respectively.

The apparatus 20 also includes a vibratory generator 60. While an exemplary embodiment of a vibratory generator is discussed below, it will be recognized that other generators may be used as well. For example, an alternative generator may not have the motors mounted on the apparatus, but on a stationary support structure instead. The motors may be coupled to and drive rotating eccentric weights mounted on the apparatus, however.

Returning then to FIGS. 1 and 2, the vibratory generator 60 may comprise a beam 62 that spans the springs 40. The beam 62 is coupled to the container 22 by rocker leg assemblies 64, 66, disposed generally at or near the input end 24 and the output end 26, respectively. The beam 62 is also coupled to the container 22 by the springs 44, which springs 44 span the beam 62 between the rocker leg assembly 64 and the rocker leg assembly 66. In this manner, the container 22 has freedom of movement constrained only by the rocker leg assemblies 64, 66 and the springs 44 in response to a vibratory force produced by the vibratory generator 60. In addition, the vibratory generator 60 may include a pair of eccentric weight motors mounted on opposite sides of the beam 62, one of which is shown in FIG. 1 at 68.

The vibratory force produced by the vibratory generator 60 is generally represented by the double-ended arrow 80 in FIG. 2. It will be recognized that the vibratory force 80 is directed generally along a linear path which is (i) displaced from the generally horizontally extending longitudinal axis 30 and (ii) displaced from the center of gravity of the container 22. As will also be appreciated, the plurality of resilient members 40, 42, 44 mount the container 22 for unconstrained vibratory movement in response to the vibratory force 80 produced by the vibratory generator 60.

The vibratory force 80 causes objects to move within the container 22. Objects placed in the container 22 are moved in a generally rising and falling path of rolling movement along the curved inner surface 28 of the container 22. The rolling movement occurs as the objects are being transported in the direction of the generally horizontally extending longitudinal axis 30 from the input end 24 toward the output end 26 of the container 22.

To assist the movement of the objects along the axis 30, the container 22 may be mounted such that the generally horizontally extending longitudinal axis 30 is actually inclined downwardly from the input end 24 to the output end 26. The downward inclination of the container 22 causes the objects to be transported, in part, by gravity from the input end 24 toward the output end 26. However, it will be recognized that this inclination is not required in all embodiments of the present disclosure.

It will be recognized from FIG. 2, for example, that the container 22 may include a pair of outwardly extending arms 90, 92. The arms 90, 92 may each include an integrally associated ballast weight, such as the weight 94 (see FIG. 2) that is on the side of the container 22 opposite the vibratory generator 60. The ballast weights assist in producing the vibratory force 80, and the vibratory force 80 may be modified by modifying, for example, the placement and size of the ballast weights.

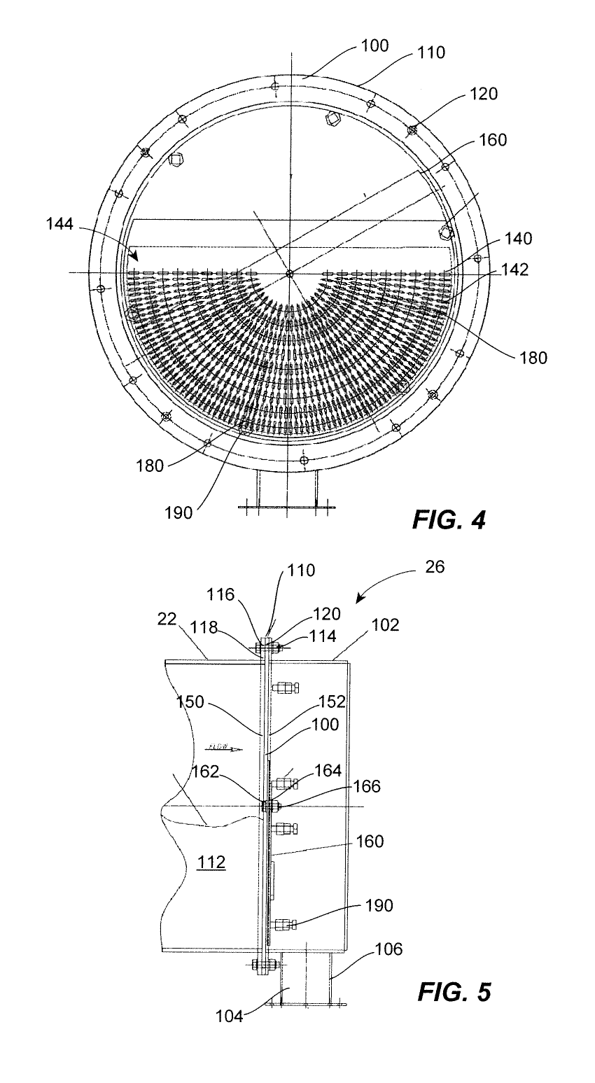

Turning now to FIG. 2 and FIG. 4, it will be recognized that coupled to the container 22 is a barrier 100. As illustrated in FIG. 5, the barrier 100 may be coupled at the output end 26 of the container 22. However, according to the present disclosure, the barrier 100 may be coupled to the container 22 at any position spaced from the input end 24, for example at some point along the longitudinal axis 30 of the container 22 between the input end 22 and the output end 26. Moreover, to the extent that the barrier 100 is disposed at the output end 26, this does not require that the barrier 100 be disposed at the very point of discharge of material from the apparatus 20. For example, as is illustrated in FIG. 5, a discharge chute or cap 102 may be disposed downstream from the barrier 100, and may direct material discharged from the container 22, through a passage 104 defined by a conduit 106, for example.

As seen best in FIG. 5, the barrier 100 may have an outer perimeter 110 that is larger than the inner perimeter of a chamber 112 defined by the surface 28 of the wall of the container 22. This permits the barrier 100 to be coupled to the container 22 by passing a fastener 114, such as a bolt, through openings 116 in a flange 118 joined to the container 22 and openings 120 near the outer perimeter 110 of the barrier 100. It is also seen in FIG. 5 that the fasteners 114 may be used to attach the chute or cap 102 to the container 22 in a similar fashion.

The barrier 100, which may be in the form of a circular plate as illustrated, occludes the chamber 112 completely, such that no material may pass around the barrier 100. It will be recognized that this is only one embodiment of the present disclosure. The barrier 100 need not fully occlude the chamber at the position at which the barrier 100 is coupled to the container 22. Instead, according to the present disclosure, the barrier 100 may at least partially occludes the chamber 112.

The barrier 100 has a plurality of openings 140 disposed therethrough. As a consequence, while material may not pass around the barrier 100, material may still pass through the barrier 100. As illustrated, the plurality of openings 140 are in the form of elongated slots 142 arranged along radii extending from the center of the barrier over a semicircular region 144 of the barrier 100.

It will be recognized that the shape and arrangement of the openings 140 are not limited to those illustrated in FIG. 4. For example, rather than an elongated slot, an opening that is circular or elliptical may be used. For that matter, the openings may have other more complex shapes (e.g., cross, etc.) or irregular shapes. The size of the openings may also vary. Additionally, while a uniform arrangement has been shown, wherein the openings 140 have a regular spatial placement relative to each other and a constant spacing, such uniformity need not be present in all embodiments of the present disclosure. Spatial placement and spacing may vary.

Moreover, while the size and shape of the openings, their spatial placement, and their spacing may vary, this variation need not be with respect to the entirety of the plurality of openings 140. Instead, particular regions or portions or the plurality of openings 140 may vary relative to other regions or portions. As a consequence, a first region may have elongated slots with a particular cross-sectional area, a second region with circular openings with a cross-section area smaller than that of the slots, and a third region with a single opening with a cross section area greater than the slots and the circular openings when taken in the aggregate.

As such, the openings 140 of the barrier 100 may provide for the controlled passage of materials from one side 150 of the barrier 100 to the other 152. That is, only material of a particular cross-sectional area may pass through the openings 140. However, the present disclosure includes a further structure for controlling the passage of materials from one side 150 to the other 152 of the barrier 100: agate 160.

The gate 160, as illustrated in FIGS. 4 and 5, is a semicircular plate that is coupled to the barrier 100. In particular, the barrier 100 has an opening 162 and the gate 160 has an opening 164 that may be aligned with each other, and through which may be dispose a fastener 166, such as a bolt. This coupling between the barrier 100 and the gate 160 permits the gate 160 to move relative to the barrier 100. Specifically, the coupling permits the gate 160 to pivot about the fastener 166 relative to the barrier 100.

It will be recognized that the arrangement of barrier 100 and gate 160 illustrated in FIGS. 4 and 5 is only one such embodiment. The coupling may instead be provided by a shaft, for example, that is fixedly attached to the barrier 100 and on which the gate 160 is mounted via a bearing, for example. Moreover, the gate 160 need not be coupled to the barrier 100 directly, and thus to the container 22 indirectly via the barrier 100. Instead, the gate 160 may be coupled to the container 22 directly, or to the container 22 indirectly via a structure other than the barrier 100.

Further, the illustrated movement of the gate 160 relative to the barrier 100 is only one possible motion that may be used. Rather than rotation about a pivot, the gate may translate relative to the barrier 100 in a plane parallel to the plane in which the surface 152 of the barrier 100 is disposed. This would permit the gate 160 to expose regions of the plurality of openings 144 that are not sectors of a circle with its center at the pivot of the gate 160. Other, more complex, motions may also be possible.

As illustrated, the gate 160 is solid, at least relative to the portion of the gate 160 that overlies the plurality of openings 140. As a consequence, it may be possible to significantly limit or even prevent material from flowing through that portion of the plurality of openings 140 that the gate 160 overlies. However, according to other embodiments, the gate 160 may also have openings therethrough, over the entirety of the gate 160, or only a region thereof. As such, the gate 160 may be used to control the passage of material through the openings 140 by having a solid portion overlie the openings 140, by having the openings in the gate 160 aligned with the openings 140, or by having the openings in the gate 160 misaligned with the openings 140.

As also illustrated, the gate 160 may be coupled to the container 22 (or, directly, the barrier 100) to limit the motion of the gate 160 from a first position, wherein the gate 160 occludes a first portion of the plurality of openings 140, to a second position, wherein the gate 160 occludes a second portion of the plurality of openings 140. In particular, the gate 160 has one or more openings 180, in the form of slots, in which another structure may be received to limit the motion of the gate 160 from its present position. For example, one or more fasteners 190, in the form of bolts, are disposed about the barrier 100, which fasteners 190 may be received in the in the openings 180. Accordingly, the gate 160 may be held in a plurality of positions defined by the alignment of the openings 180 with the fasteners 190.

Alternatively, as illustrated in FIG. 2, an actuator 200 may be coupled to the gate 160. The actuator 200 may be, for example, a hydraulic or pneumatic actuator 200 that moves the gate 160 along a continuum of positions relative to the barrier 100, and may be maintained in place to limit the motion of the gate 160 relative to the barrier 100, and particularly the openings 140. Alternatively, other mechanical devices, such as cams or gears, may be used with electric motors to provide a suitable actuator 200.

Furthermore, the actuator 200 may be coupled to a controller or control system 220. The controller 220 may be selected according to the nature of the actuator 200. For example, a pneumatic actuator 200 may be coupled to a controller 220 in the form of a valve that is manually manipulated to move the actuator 200, and thereby cause movement of the gate 160. Alternatively, an electromechanical valve may be used in conjunction with a programmable controller to define a control system 220, which control system 220 may also be coupled to flow sensors disposed in the container 22 to permit automation. Still other alternatives may also be possible.

It is believed that the present disclosure may have several benefits, one or more of which may be present in a particular embodiment according to the present disclosure. As one example, the barrier 100 and gate 160 may be used to control flow in a container 22 being used as a vibratory grinding mill, so as to retain sufficient material to maintain a particular bed depth within the container 22. The bed depth, in turn, may have an effect on grind yield.

What is claimed is:

1. A vibratory apparatus with controlled discharge, comprising:
a surface having an input end and an output end;
a vibratory generator coupled to the surface to cause material to move along the surface;
a barrier coupled to the surface and having a plurality of openings disposed therethrough to provide for controlled passage of materials from an upstream side of the barrier to a downstream side; and
a solid gate disposed to one side of the barrier, the gate moveable relative to the barrier between a first position wherein a first portion of the plurality of openings are occluded and a second position wherein a second portion of the plurality of openings are occluded, the first portion being different than the second portion.

2. The vibratory apparatus of claim 1, wherein the barrier has a barrier center and the gate has a gate center, and the gate is attached to the barrier with the gate center aligned with the barrier center so that the gate is pivotable relative to the barrier.

3. The vibratory apparatus of claim 2, wherein the barrier has a shape that is at least a sector of a circle, the gate has a shape that is at least a sector of a circle, and the first and second fractions are in the shape of a sector of a circle.

4. The vibratory apparatus of claim 3, wherein the gate is disposed on the downstream side of the barrier.

5. The vibratory apparatus of claim 4, wherein the plurality of openings comprises a plurality of elongated slots, the elongated slots arranged along radii extending from the center of the barrier.

6. The vibratory apparatus of claim 1, wherein the barrier is coupled to the output end of the surface.

7. The vibratory apparatus of claim 1, further comprising an actuator coupled to the gate to move the gate between the first and second positions, and a controller coupled to the actuator to control the actuator to move the gate between the first and second positions.

8. The vibratory apparatus of claim 7, wherein the actuator comprises a pneumatic actuator, a hydraulic actuator or a mechanical actuator.

9. The vibratory apparatus of claim 7, further comprising a flow sensor disposed along the surface, the flow sensor coupled to the controller to automate control of the actuator.

10. The vibratory apparatus of claim 1, further comprising a drum, the drum defining the surface and a chamber.

11. The vibratory apparatus of claim 10, wherein the barrier is attached to the drum and completely occludes the chamber so that no material may pass around the barrier.

12. The vibratory apparatus of claim 10, further comprising a plurality of resilient members attached to the drum to resiliently support the drum above a base.

13. A method of operating a vibratory apparatus having controlled discharge, the apparatus comprising a container having an input end and an output end, a vibratory generator coupled to the container to cause material to move through the container between the input end and the output end, and a barrier coupled to the surface and having a plurality of openings disposed therethrough to provide for controlled passage of materials from an upstream side of the barrier to a downstream side, the method comprising:
disposing a solid gate to one side of the barrier at a first position wherein a first portion of the plurality of openings are occluded; and
moving the solid gate to a second position wherein a second portion of the plurality of openings are occluded, the first portion being different than the second portion,
the movement of the solid gate between the first and second positions varying the bed depth of material within the container.

14. The method according to claim 13, further comprising:
moving the solid gate between the first and second positions pneumatically, hydraulically, or mechanically according to a signal from a controller.

15. The method according to claim 14, further comprising:
sensing a flow rate of material in the container; and
moving the solid gate between the first and second positions in response to the sensed flow rate.
